(19) United States
(12) Patent Application Publication
(10) Pub. No.: US 2004/0015343 A1
(43) Pub. Date: Jan. 22, 2004

(54) System and method for customizing the language displayed on the interface of an image processing deivce

(75) Inventor: Fumiharu Nakayama, Yokohama-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/199,087

(22) Filed: Jul. 22, 2002

(51) Int. Cl. G06F 17/20

(52) U.S. Cl. 704/8

(57) ABSTRACT

A system and method for selecting a language for a user interface of a hardcopy device includes receiving an indication that no language has been chosen for the hardcopy device, and downloading first data to the hardcopy device to prompt a user to select a language. An indication of the selected language is received, and second data is downloaded to the hardcopy device corresponding to the selected language, the second data enabling the hardcopy device to display content in the user interface of the hardcopy device in the selected language.

### FIELD OF THE INVENTION

The present invention relates generally to image processing, and more particularly to a system and method for customizing the language on the display panel of an image processing device.

### BACKGROUND OF THE INVENTION

Hardcopy devices, such as printers, copiers and multi-function peripherals, typically include a user interface or display. The interface provides status information to the user, and also provides menus and screens prompting the user to select or specify instructions and parameters for performing a function, such as copying or scanning a document. The interface includes text presented in a language corresponding to the language used by the user.

Manufacturers of hardcopy devices typically sell them to a variety of countries across the world, including North America, South America, Europe and Asia. The languages spoken, written and read in these parts of the world all vary and include, for example, English, Spanish, French, German, Japanese and Chinese, as well as several other languages. As a result of the different languages used in the different parts of the world and the marketing of hardcopy devices in the different parts of the world, it is necessary for the hardcopy device to display text on the interface in the applicable language.

To handle this language requirement, the hardcopy device may be programmed prior to shipment to a particular country with the applicable language of that country. This arrangement requires prior knowledge of the intended destination of the hardcopy device, and also requires that the hardcopy devices be programmed differently based on the intended destination of the hardcopy device. Alternatively, each of the languages supported by the hardcopy device may be programmed into the hardcopy device prior to shipment, and the purchaser of the hardcopy device then selects the applicable language when starting up the device. Programming the hardcopy device with all of the possible languages requires the use of a considerable amount of storage, thereby requiring additional memory space in the hardcopy device.

### SUMMARY OF THE INVENTION

Briefly, in one aspect of the invention, a method for selecting a language for a user interface of a hardcopy device includes receiving an indication that no language has been chosen for the hardcopy device, and downloading first data to the hardcopy device to prompt a user to select a language. An indication of the selected language is received, and second data is downloaded to the hardcopy device corresponding to the selected language, the second data enabling the hardcopy device to display content in the user interface of the hardcopy device in the selected language.

In another aspect of the invention, the downloaded data is stored in a memory of the hardcopy device.

In yet another aspect of the present invention, an indication is received to change the content displayed in the user interface from the selected language to a second language and an indication as to the type of change. At least data of the second language is identified that corresponds to the content being displayed in the user interface, and the identified data of the second language is downloaded to the device, wherein the downloaded data of the second language changes the content being displayed in the user interface to the second language.

### BRIEF DESCRIPTION OF THE DRAWINGS

FIG. 1 is a block diagram of a communication system consistent with the present invention.

FIG. 2 is a flow diagram of a process for selecting a display language for a hardcopy device consistent with the present invention.

FIGS. 3A and 3B are diagrams of storage requirements for a conventional hardcopy device and a hardcopy device consistent with the present invention, respectively.

FIG. 4 is a flow diagram of a process for changing the display language for a hardcopy device consistent with the present invention.

### DETAILED DESCRIPTION OF THE PREFERRED EMBODIMENT

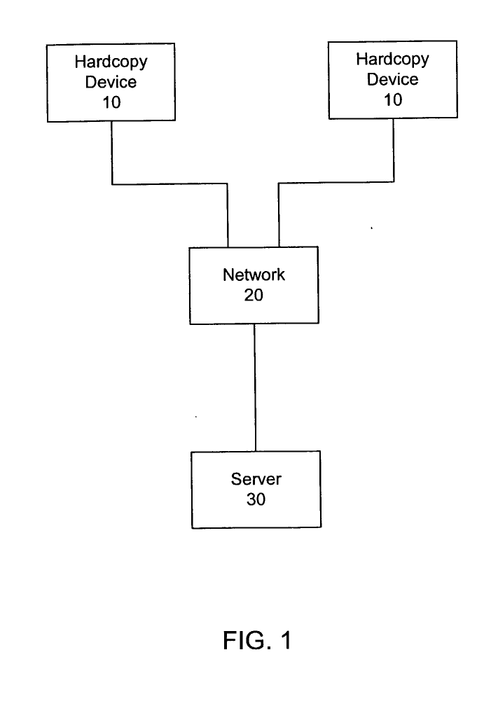

FIG. 1 is a block diagram of a communication system consistent with the present invention. As shown in FIG. 1, the communication system includes one or more hardcopy devices 10, a network 20, and a server 30. Each of the hardcopy devices 10 and the server 30 are coupled to the network 20. The network 20 may be implemented as a local network, such as a LAN, or as a public network, such as the Internet.

The hardcopy device 10 can perform the functions of one or more devices including a printer, a fax machine, a copier, a plotter, a scanner or any other functional device that generates hardcopies of images or text. If the hardcopy device 10 provides the functionality of two or more devices, it may be referred to as a multi-function peripheral (MFP). The hardcopy device 10 may have a CPU, a main memory, a ROM, a storage device and a communication interface all coupled together via a bus. The hardcopy device 10 may also have a communication interface to provide a two-way data communication coupling via a network link to the network 20. The network link to the network 20 enables the hardcopy device 10 to receive data from and to output data to the server 30. Instead of a network link, the hardcopy device 10 may use a Universal Serial Bus (USB) to connect to a USB port on the server 30.

The server 30 includes a CPU, a main memory, a ROM, a storage device and a communication interface all coupled together via a bus in one embodiment consistent with the present invention. The CPU may be implemented as a single microprocessor or as multiple processors for a multi-processing system. The main memory is preferably implemented with a RAM and a smaller-sized cache. The ROM is a non-volatile storage, and may be implemented, for example, as an EPROM or NVRAM. The storage device can be a hard disk drive or any other type of non-volatile, writable storage.

The communication interface for the server 30 provides a two-way data communication coupling via a network link to the network 20. For example, if the communication interface is an integrated services digital network (ISDN) card or a modem, the communication interface provides a data communication connection to the corresponding type of telephone line. If the communication interface is a local area network (LAN) card, the communication interface provides a data communication connection to a compatible LAN. Wireless links are also possible. In any such implementation, the communication interface sends and receives electrical, electromagnetic or optical signals, which carry digital data streams representing different types of information, to and from the network 20.

If the network is implemented as the Internet, the server 30 can transmit a requested code for an application program or requested data through the Internet, an ISP, the local network and the communication interface. The received code or data can be executed by the CPU in the hardcopy device 10, stored in the storage device, or stored in some other non-volatile storage for later execution. In this manner, the hardcopy device 10 may obtain application code in the form of a carrier wave.

In operation, the hardcopy device 10 communicates with the server 30 via the network 20 or via a more direction connection, such as the USB. This communication enables the hardcopy device 10 and the server 30 to send and receive information between them. To provide the communication, the hardcopy device 10 and server 30 may use a network protocol such as TCP/IP or SNMP, which is a protocol for monitoring and managing systems and devices in a network.

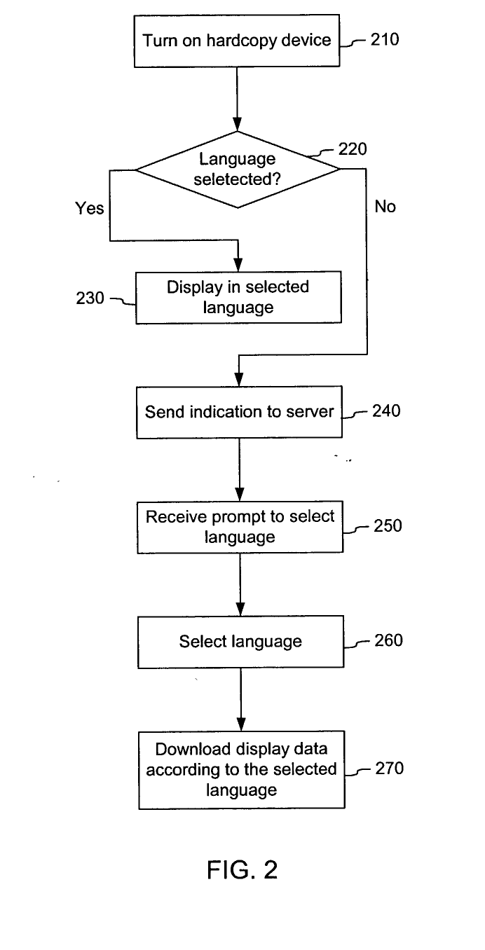

FIG. 2 is a flow diagram of a process for selecting a display language for a hardcopy device consistent with the present invention. As shown in FIG. 2, a user first turns on the hardcopy device 10 (step 210). The hardcopy device 10 may have a button or a switch to turn the hardcopy device on or off.

When turned on, it is determined whether a language has been selected for the hardcopy device 10 (step 220). The selected language determines the language in which the text is presented in the display or interface of the hardcopy device. The interface provides status information to the user, and also provides menus and screens prompting the user to select or specify instructions and parameters for performing a function, such as copying or scanning a document. The selected language may be, for example, English, Spanish, French, German, Japanese and Chinese, or other known languages.

The hardcopy device 10 includes a section stored in memory that holds the data for the selected language. This language section may be a dedicated section in the memory of the hardcopy device 10, or in any available area of the memory of the hardcopy device 10. The hardcopy device 10 references the language section of the memory to determine whether a language has been selected. If no language has been selected, then there would be no data in the language section. If the language section is in a dedicated section of the memory, the hardcopy device knows the location of the language section and can determine if a language has been selected by sensing whether any data is present in the language section. If the language section is not in a dedicated section of the memory, the language data may include an identifier that is searched for by the hardcopy device 10. If the identifier is not present, then no language has been selected.

If a language has been selected, then the interface of the hardcopy device 10 is displayed in the selected language (step 230). As described above, the selected language may be English, Spanish, French, German, Japanese and Chinese, or other known languages. For the interface to be displayed in the selected language, the hardcopy device 10 references the language data of the selected language stored in the language section of the memory of the hardcopy device 10.

If no language has been selected, an indication is sent from the hardcopy device 10 to the server 30 (step 240). The indication informs the server 30 that no language has been selected yet for the hardcopy device 10 and identifies the location of the hardcopy device 10 that is sending the indication. The indication may be sent as a message to the server 30 via the network 20 according to any applicable network protocol. The hardcopy device 10 is configured to recognize where to send the indication. For example, the hardcopy device may be configured to store the Internet address of the server 30 to which to send the indication.

The server 30 receiving the indication identifies the hardcopy device 10 sending the indication. The server 30 also recognizes from the indication that the hardcopy device has not selected a language in which to display its interface. In response to this recognition, the server 30 transmits a language selection query to the identified hardcopy device 10. The language selection query is transmitted over the network 20, preferably using the same protocol or message format by which the indication was transmitted to the server 30. The language selection query is a message that identifies the different languages supported by the hardcopy device 10.

The language selection query is received by the hardcopy device 10 (step 250). In response to the reception of the language selection query, a menu or window is displayed in the interface of the hardcopy device that identifies the languages that may be selected by the user and prompts the user to select one of the identified languages. The menu or window is structured and designed to enable the user to understand that the user is being prompted to select a language. The menu or window preferably includes prompts in each language including the language understood by the user.

In response to the prompt, the user selects the desired language (step 260). The user may make the selection through the interface. For example, the selection may be effected using a touch pad on the surface of the interface or by depressing one or more different buttons on the hardcopy device 10. An indication of the language selected by the user is sent to the server 30 that transmitted the language selection query to the hardcopy device 10. This indication may be transmitted to the server 30 using any applicable network protocol and message format, such as the protocol and format used for transmitting the indication determining that no language had been selected.

The server 30 then downloads display data corresponding to the selected language identified in the indication (step 270). The display data corresponds to the content that may be displayed in the interface of the hardcopy device 10. The display data that is downloaded is tailored to display data in the language selected by the user at the hardcopy device 10. The actual content of the display data that is downloaded may be all of the content that can be displayed, including textual and graphical elements, or just the textual elements that can be displayed. In the latter example, the hardcopy device 10 would include the graphical elements of the display data when it was initially configured, but not the textual elements of the display data.

The server 30 includes an area in its memory in which the display data for each of the languages supported by the hardcopy device 10 is stored. After receiving the indication of which language had been selected by the user, the server 30 references this area of memory, identifies the display data for the selected language and downloads the identified display data to the hardcopy device 10. The display data may be downloaded to the hardcopy device 10 using any applicable network protocol and message format. The display data downloaded to the hardcopy device 10 is stored in the memory of the hardcopy device, such as in the language section of the memory.

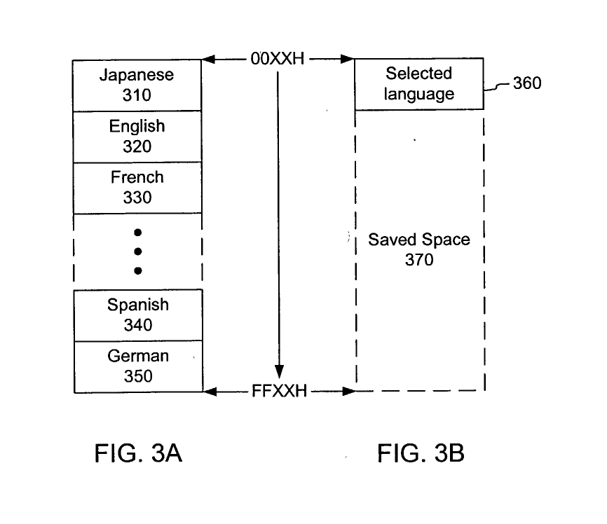

Consistent with the present invention and as described above, the display data for a particular language is not present in the hardcopy device 10 until a language is selected and the display data is downloaded to the hardcopy device 10. FIGS. 3A and 3B are diagrams of storage requirements for storing display data in a conventional hardcopy device and a hardcopy device consistent with the present invention, respectively.

As shown in FIG. 3A, the memory in the conventional hardcopy device stores the display data for Japanese 310, English 320, French 330, Spanish 340 and German 350, as well as any other languages that are supported by the hardcopy device. In the conventional hardcopy device, the display data for each of the languages supported by the hardcopy device is stored in the hardcopy device when it is initially manufactured. Depending upon the number of languages supported by the hardcopy device, the amount of memory required to store the display data for each language may be substantial.

As shown in FIG. 3B and as described above, only the display data for the selected language 360 is stored in the memory of the hardcopy device 10, although it is possible to store the display data of more than one language as well. As a result of limiting the amount of display data stored in the hardcopy device 10, there may be a substantial amount of saved space 370 in the memory of the hardcopy device 10. The saved space 370 may be used to store other data or information. Alternatively, the amount of memory in the hardcopy device 10 may be reduced by the amount corresponding to the amount of saved space 370.

As also described above, the display data for each of the other languages supported by the hardcopy device, as well as the selected language, is stored in the server 30. Since the server 30 is capable of supporting multiple hardcopy devices 10, only the server 30 has the storage requirement shown in FIG. 3A, whereas the hardcopy devices 10 only have a storage requirement corresponding to the selected language 360. It is possible, however, that the display data for each language may be distributed across one or more servers 30. In this case, the hardcopy device 10 may contact the applicable server 30 based on which language is selected by the user.

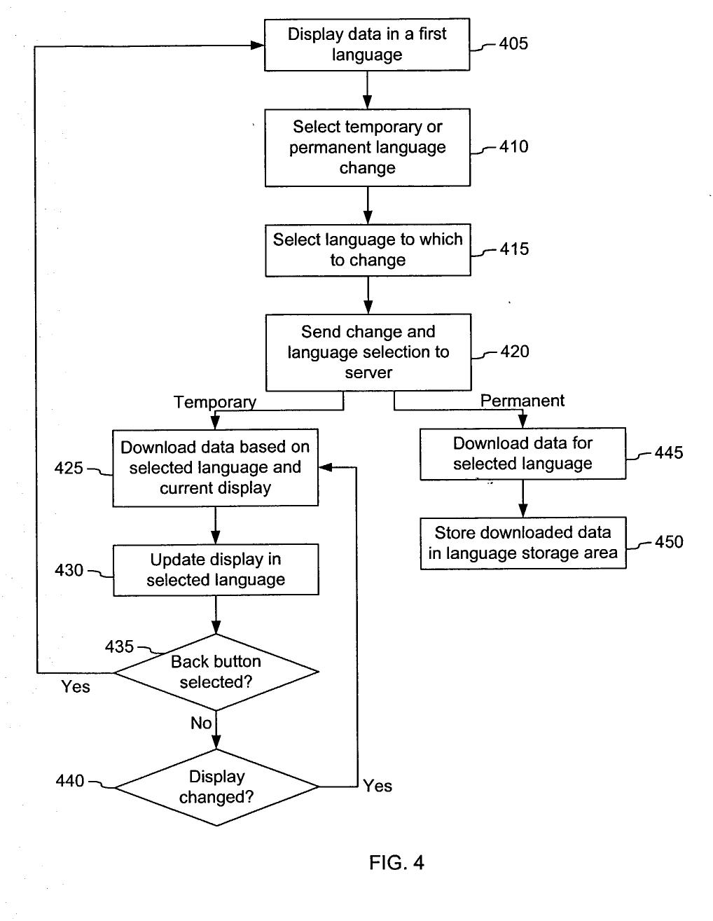

With the display data for the selected language stored in the memory of the hardcopy device 10, the content of the interface of the hardcopy device 10 is displayed with text in the selected language. It is possible that during the operation of the hardcopy device 10 that a user may want to change the language being displayed in the interface. FIG. 4 is a flow diagram of a process for changing the display language for a hardcopy device consistent with the present invention.

As shown in FIG. 4, the hardcopy device displays data in the interface in a first language (step 405). The first language corresponds to the language currently being displayed on the interface of the hardcopy device 10. As described above, in response to the selection of the language by the user, the server 30 downloads the display data for the selected language, which is stored in the memory of the hardcopy device 10. The hardcopy device 10 uses the display data stored in the memory to display the text in the interface in the first language.

At any time during the operation of the hardcopy device 10, the user can select a temporary or permanent language change (step 410). To make the selection, the user may depress a language change button on the hardcopy device 10. There may be a separate button for a temporary or permanent change. Alternatively, the interface may include a touch screen through which the user selects the language change. For the temporary change, the interface changes to a different language from the first language until the user indicates that the temporary change is complete, such as be depressing a change complete button or selecting the completion of the language change with a touch screen. For the permanent change, the language displayed in the interface is permanently changed to a language other than the first language. After making a permanent change to the other language, the first language is only displayed again by performing another permanent change to the first language.

The user also selects which language to which to change (step 415). To determine to which language the user may change, the interface may display the languages that are supported by the hardcopy device 10. To make the selection, the user may depress a button corresponding to the desired language or make the selection with a touch screen.

Information regarding the type of change and the language selected by the user is sent to the server 30 (step 420). In addition to this information, an indication of the content being displayed on the interface is also sent to the server 30. The information may be sent as a message to the server 30 via the network 20 according to any applicable network protocol. The hardcopy device 10 is configured to recognize where to send the information. For example, the hardcopy device may be configured to store the Internet address of the server 30 to which to send the information.

In response to receiving the information from the hardcopy device 10, the server 30 determines the type of change selected by the user at the hardcopy device 10. If the type of change selected by the user is a temporary change, the server 30 downloads the display data of the selected language corresponding to the content being displayed on the interface (step 425). The display data of the selected language that is downloaded to the hardcopy device 10 only needs to include the display data corresponding to the content being displayed in the interface. For example, if the content currently being displayed on the interface is a prompt to enter the number of copies to make of a document, the display data of the selected language that is downloaded only needs to correspond to the content of the prompt. The downloaded data is stored in the memory of the hardcopy device. The memory area in which the downloaded data is stored may be a temporary buffer.

The hardcopy device 10 uses the downloaded data to update the content being displayed on the interface into the selected language (step 430). For example, if the first language was English, the selected temporary language was French, and the interface was displaying a menu with a variety of settings to be selected by the user, the update of the display would change the text being displayed from English to French. Although the display data of the selected language is used to display the content in the interface, the display data of the first language remains in the memory of the hardcopy device 10.

After the display has been updated, the user may continue to operate the hardcopy device 10 with the interface displaying content in the selected language or return to displaying the content in the first language. To determine whether to return to displaying the content in the first language, the hardcopy device 10 senses whether a back or change complete button has been selected by the user (step 435). The user may select the back button by depressing a change complete button or selecting the completion of the language change with a touch screen. If the change complete button has been selected, the interface is updated to again display content in the first language.

If the change complete button has not been selected, the hardcopy device determines whether the content being displayed on the interface has changed (step 440). The content being displayed on the interface may change, for example, to a different menu after selections have been made by the user or to update the status of the hardcopy device 10. If the display has changed, an indication is sent to the server 30 requesting the display data of the selected language corresponding to the changed display. In response, the server 30 downloads the display data of the selected language for the changed display (step 425), and the hardcopy device uses the downloaded data to show the changed display of the interface in the selected language (step 430). The process of downloading display data of the selected language may continue as long as the temporary language change remains in effect, and the content being displayed on the interface of the hardcopy device 10 continues to change.

If the type of change selected by the user was a permanent change, the server 30 downloads all of the display data for the selected language (step 445). The display data of the selected language corresponds to the content that may be displayed in the interface of the hardcopy device 10. The server 30 includes an area in its memory in which the display data for each of the languages supported by the hardcopy device 10 is stored. After determining which language had been selected by the user and that the change is permanent, the server 30 references this area of memory, identifies the display data for the selected language and downloads the identified display data to the hardcopy device 10. The display data may be downloaded to the hardcopy device 10 using any applicable network protocol and message format.

The display data downloaded to the hardcopy device 10 is stored in the memory of the hardcopy device (step 450). The downloaded display data of the selected language may be stored, for example, in the language section of the memory. Since the language changed selected by the user is a permanent change, the downloaded display data may be stored in the memory of the hardcopy device 10 so as to overwrite the display data of the first language. By overwriting the display data of the first language, the hardcopy device 10 would not need as much memory space. It is possible, however, to maintain the display data of the first language. In this case, if the user were to make a permanent change back to the first language, it would be unnecessary to download the data from the server 30. After making the permanent change and downloading all of the display data of the selected language, the content being displayed in the interface of the hardcopy device 10 will be in the selected language. For example, if the first language is English, and the selected language is French, the content being displayed in the interface of the hardcopy device 10 after the download will be in French.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method for selecting a language for a user interface of a hardcopy device, comprising:
receiving an indication that no language has been chosen for the hardcopy device;
downloading first data to the hardcopy device to prompt a user to select a language;
receiving an indication of the selected language; and
downloading second data to the hardcopy device corresponding to the selected language, the second data enabling the hardcopy device to display content in the user interface of the hardcopy device in the selected language.

2. A method according to claim 1, wherein the downloaded data is stored in a memory of the hardcopy device.

3. A method according to claim 1, further comprising:
receiving an indication to change the content displayed in the user interface from the selected language to a second language and an indication as to the type of change;
identifying at least data of the second language that corresponds to the content being displayed in the user interface; and
downloading the identified data of the second language to the device, wherein the downloaded data of the second language changes the content being displayed in the user interface to the second language.

4. A method according to claim 3, wherein the type of change is one of a permanent change and a temporary change.

5. A method according to claim 4, further comprising downloading additional data of the second language in response to an update to the content displayed in the user interface if the type of change is temporary, wherein the additional data enables the updated content displayed in the user interface to be displayed in the second language.

6. A method according to claim 4, further comprising downloading additional data of the second language if the type of change is permanent, wherein the downloaded data of the selected language is stored in a memory of the hardcopy device and all of the downloaded data of the second language replaces the data of selected language stored in the memory of the hardcopy device.

7. A method for changing the language of a user interface on a hardcopy device, comprising:
downloading data of a first language into a memory of the hardcopy device, the user interface displaying content in the first language based on the stored data of the first language;
receiving an indication to change the content displayed in the user interface from the first language to a second language and an indication as to a type of change;
identifying at least data of the second language that corresponds to the content being displayed in the user interface; and
downloading the identified data of the second language to the device, wherein the downloaded data of the second language changes the content being displayed in the user interface to the second language.

8. A method according to claim 7, wherein the type of change is one of a permanent change and a temporary change.

9. A method according to claim 8, further comprising downloading additional data of the second language in response to an update to the content displayed in the user interface if the type of change is temporary, wherein the additional data enables the updated content displayed in the user interface to be displayed in the second language.

10. A method according to claim 8, further comprising downloading additional data of the second language if the type of change is permanent, wherein all of the downloaded data of the second language replaces the data of selected language stored in the memory of the hardcopy device.

11. A computer readable medium operable on a computer system configured to select a language for a user interface of a hardcopy device, the computer readable medium configured to:
receive an indication that no language has been chosen for the hardcopy device;
download first data to the hardcopy device to prompt a user to select a language;
receive an indication of the selected language; and
download second data to the hardcopy device corresponding to the selected language, the second data enabling the hardcopy device to display content in the user interface of the hardcopy device in the selected language.

12. A computer readable medium according to claim 11, wherein the downloaded data is stored in a memory of the hardcopy device.

13. A computer readable medium according to claim 11, further configured to:
receive an indication to change the content displayed in the user interface from the selected language to a second language and an indication as to the type of change;
identify at least data of the second language that corresponds to the content being displayed in the user interface; and
download the identified data of the second language to the device, wherein the downloaded data of the second language changes the content being displayed in the user interface to the second language.

14. A computer readable medium according to claim 13, wherein the type of change is one of a permanent change and a temporary change.

15. A computer readable medium according to claim 14, further configured to download additional data of the second language in response to an update to the content displayed in the user interface if the type of change is temporary, wherein the additional data enables the updated content displayed in the user interface to be displayed in the second language.

16. A computer readable medium according to claim 14, further configured to download additional data of the second language if the type of change is permanent, wherein the downloaded data of the selected language is stored in a memory of the hardcopy device and all of the downloaded data of the second language replaces the data of selected language stored in the memory of the hardcopy device.

17. A computer system configured to select a language for a user interface of a hardcopy device, the computer system comprising:
a processor; and
a memory, coupled to the processor, the memory comprising a plurality of instructions executed by the processor, the plurality of instructions configured to:
receive an indication that no language has been chosen for the hardcopy device;
download first data to the hardcopy device to prompt a user to select a language;
receive an indication of the selected language; and
download second data to the hardcopy device corresponding to the selected language, the second data enabling the hardcopy device to display content in the user interface of the hardcopy device in the selected language.

18. A computer system according to claim 11, wherein the downloaded data is stored in a memory of the hardcopy device.

19. A computer system according to claim 11, the memory further comprising instructions configured to:
receive an indication to change the content displayed in the user interface from the selected language to a second language and an indication as to the type of change;
identify at least data of the second language that corresponds to the content being displayed in the user interface; and
download the identified data of the second language to the device, wherein the downloaded data of the second language changes the content being displayed in the user interface to the second language.

20. A computer system according to claim 13, wherein the type of change is one of a permanent change and a temporary change.

21. A computer system according to claim 14, the memory further comprising an instruction further configured to download additional data of the second language in response to an update to the content displayed in the user interface if the type of change is temporary, wherein the additional data enables the updated content displayed in the user interface to be displayed in the second language.

22. A computer system according to claim 14, the memory further comprising an instruction further configured to download additional data of the second language if the type of change is permanent, wherein the downloaded data of the selected language is stored in a memory of the hardcopy device and all of the downloaded data of the second language replaces the data of selected language stored in the memory of the hardcopy device.
